(19) United States
(12) Patent Application Publication
(10) Pub. No.: US 2024/0380942 A1
(43) Pub. Date: Nov. 14, 2024

(54) TELEVISION SUPPORTING IMPROVED SLEEP ENVIRONMENT

(71) Applicant: Sony Group Corporation, Tokyo (JP)

(72) Inventors: Sabrina Norton, San Diego, CA (US); Marvin DeMerchant, San Diego, CA (US)

(73) Assignee: Sony Group Corporation, Tokyo (JP)

(21) Appl. No.: 18/195,795

(22) Filed: May 10, 2023

(51) Int. Cl. H04N 21/442; H04N 21/4223; H04N 21/466; H04N 21/485

(52) U.S. Cl. CPC H04N 21/44218; H04N 21/4223; H04N 21/466; H04N 21/4852; H04N 21/4854

(57) ABSTRACT

Implementations generally relate to television viewing and sleep. In some implementations, a method includes detecting that a television is on. The method further includes detecting a user in front of the television based on one or more sensor devices. The method further includes detecting that the user is falling asleep in front of the television while the television is on based on the one or more sensor devices. The method further includes adjusting one or more environmental controls in response to detecting that the user is falling asleep.

### BACKGROUND

Many people have trouble falling and staying asleep. Some people are able fall asleep while watching television. However, televisions can awaken them during the night. For example, the bright lights from the television may wake a person up. Also, loud sounds from the television may wake a person up.

### SUMMARY

Implementations generally relate to television viewing and sleep. In some implementations, a system includes one or more processors, and includes logic encoded in one or more non-transitory computer-readable storage media for execution by the one or more processors. When executed, the logic is operable to cause the one or more processors to perform operations including: detecting that a television is on; detecting a user in front of the television based on one or more sensor devices; detecting that the user is falling asleep in front of the television while the television is on based on the one or more sensor devices; adjusting one or more environmental controls in response to detecting that the user is falling asleep.

With further regard to the system, in some implementations, the one or more sensor devices includes a motion sensor device. In some implementations, the one or more sensor devices includes a camera device. In some implementations, the one or more environmental controls include a brightness of a screen of the television. In some implementations, the one or more environmental controls include a volume of speakers of the television. In some implementations, the logic when executed is further operable to cause the one or more processors to perform operations including adjusting values of the one or more environmental controls based on artificial intelligence and machine learning. In some implementations, the logic when executed is further operable to cause the one or more processors to perform operations including determining a combination of values of the one or more environmental controls that aid the user in staying asleep using artificial intelligence and machine learning.

In some implementations, a non-transitory computer-readable storage medium with program instructions thereon is provided. When executed by one or more processors, the instructions are operable to cause the one or more processors to perform operations including: detecting that a television is on; detecting a user in front of the television based on one or more sensor devices; detecting that the user is falling asleep in front of the television while the television is on based on the one or more sensor devices; adjusting one or more environmental controls in response to detecting that the user is falling asleep.

With further regard to the computer-readable storage medium, in some implementations, the one or more sensor devices includes a motion sensor device. In some implementations, the one or more sensor devices includes a camera device. In some implementations, the one or more environmental controls include a brightness of a screen of the television. In some implementations, the one or more environmental controls include a volume of speakers of the television. In some implementations, the instructions when executed are further operable to cause the one or more processors to perform operations including adjusting values of the one or more environmental controls based on artificial intelligence and machine learning. In some implementations, the instructions when executed are further operable to cause the one or more processors to perform operations including determining a combination of values of the one or more environmental controls that aid the user in staying asleep using artificial intelligence and machine learning.

In some implementations, a method includes: detecting that a television is on; detecting a user in front of the television based on one or more sensor devices; detecting that the user is falling asleep in front of the television while the television is on based on the one or more sensor devices; adjusting one or more environmental controls in response to detecting that the user is falling asleep.

With further regard to the method, in some implementations, the one or more sensor devices includes a motion sensor device. In some implementations, the one or more sensor devices includes a camera device. In some implementations, the one or more environmental controls include a brightness of a screen of the television. In some implementations, the one or more environmental controls include a volume of speakers of the television. In some implementations, the method further includes adjusting values of the one or more environmental controls based on artificial intelligence and machine learning.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example of a television supporting sleep environment, which may be used for implementations described herein.

FIG. 2 is an example flow diagram for providing a television supporting sleep environment, according to some implementations.

FIG. 3 is an example block diagram showing an initial phase of a sleep scenario, according to some implementations.

FIG. 4 is an example block diagram showing a subsequent phase of the sleep scenario, according to some implementations.

FIG. 5 is an example block diagram showing a subsequent phase of the sleep scenario, according to some implementations.

FIG. 6 is an example block diagram showing a final phase of the sleep scenario, according to some implementations.

FIG. 7 is a block diagram of an example network environment, which may be used for some implementations described herein.

FIG. 8 is a block diagram of an example computer system, which may be used for some implementations described herein.

### DETAILED DESCRIPTION

Implementations generally relate to television viewing and sleep. As described in more detail herein, in various implementations, a system detects that a television is on. The system also detects a user in front of the television based on one or more sensor devices. The system further detects that the user is falling asleep in front of the television while the television is on based on the one or more sensor devices. The system then adjusts one or more environmental controls in response to detecting that the user is falling asleep.

As described in more detail herein, implementations build in automation and sensor detection using artificial intelligence and machine learning to support sleep through automated screen, volume, and environment adjustments. Implementations also provide television sleep mode settings that enable a user to customize their environment using ideal sleep mode settings. When the user is sleeping, the television automatically uses preset settings to adjust environment and help user fall asleep faster and stay asleep (e.g., improved light frequencies by dimming a bright screen, providing calming sound, etc.).

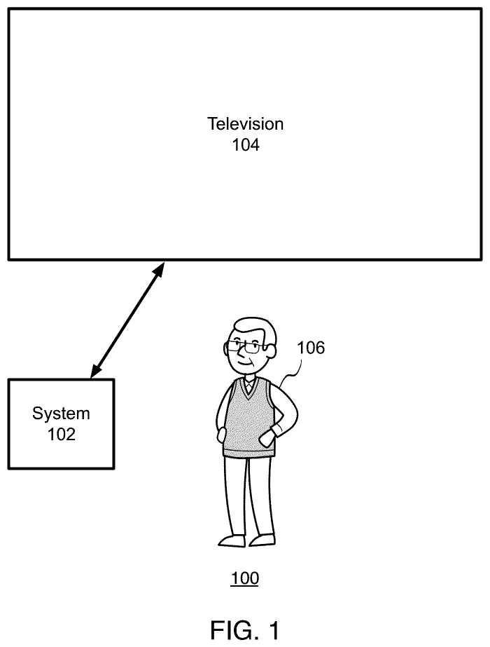

FIG. 1 is a block diagram of an example of a television supporting sleep environment 100, which may be used for implementations described herein. As shown, in various implementations, environment 100 includes a system 102 and a television 104. System 102 and television 104 may communicate directly via any suitable means such as a network (not shown) such as a Bluetooth network, a Wi-Fi network, etc. While system 102 and television 104 are shown separately, in some implementations, system 102 may be integrated with television 104. Alternatively, in some implementations, the system may be integrated with smart speakers or other device associated with television 104.

As described in more detail herein, the system detects that a television is on and that a user in front of the television based on one or more sensor devices. For example, in various implementations, the one or more sensor devices may include a motion sensor device (not shown). The motion sensor device may detect movement of the user in front of the television. In various implementations, the one or more sensor devices includes a camera device (not shown). The camera device may detect movement of the user in front of the television. The system detects that the user is falling asleep in front of the television while the television is on based on the one or more sensor devices. The system adjusts one or more environmental controls in response to the system detecting that the user is falling asleep. Various example implementations directed to these actions are described in more detail herein.

In various implementations, environment 100 may not have all of the components shown and/or may have other elements including other types of elements instead of, or in addition to, those shown herein. While system 102 performs implementations described herein, in other implementations, any suitable component or combination of components associated with system 102 or any suitable processor or processors associated with system 102 may facilitate performing the implementations described herein.

In various implementations, any neural networks and/or blockchain networks associated with system 102 may also facilitate performing the implementations described herein. For example, the system may perform various operations associated with implementations described herein using a neural network (not shown). The system may process any collected information through the neural network, which adapts or learns based on the collected information. The neural network may also be referred to as an artificial intelligence neural network or neural net. Example implementations directed to AI, machine learning, and neural networks are described in more detail herein.

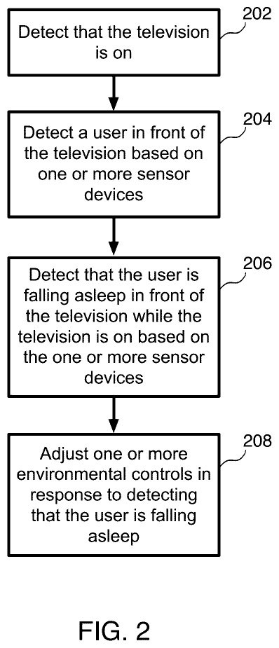

FIG. 2 is an example flow diagram for providing a television supporting sleep environment, according to some implementations. Referring to both FIGS. 1 and 2, a method is initiated at block 202, where a system such as system 102 detects that television 104 is on.

At block 204, the system detects a user in front of the television based on one or more sensor devices. In various implementations, the one or more sensor devices includes a motion sensor device. In various implementations, the one or more sensor devices includes a camera device.

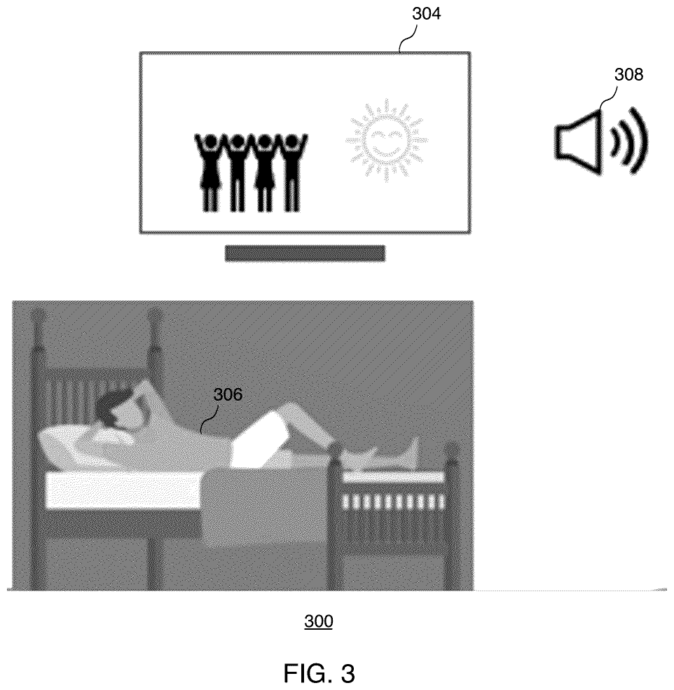

FIG. 3 is an example block diagram showing an initial phase 300 of a sleep scenario, according to some implementations. Shown is a television 304 and a user 306. Also shown is a speaker 308 representing one or more speakers of television 304. As shown in this scenario, user 306 is watching television in the user's bedroom. In this example scenario, user 306 is winding down from a busy day.

In this example scenario, the television settings are normal according to the user's preferences. The setting values may vary, depending on the particular implementation. For example, in this scenario, the brightness of the television screen is higher (e.g., at 100%, 90%, etc.). Also, the sound from the speakers may be set to the user's preference at the moment (e.g., at 70%, 60%, etc.).

At block 206, the system detects that the user is falling asleep in front of the television while the television is on based on the one or more sensor devices. In various implementations, the system may use built-in television camera and/or external sensors to detect that the user is falling asleep. For example, a motion sensor and/or a camera may determine that the user has not changed positions or has not moved in a predetermined number of minutes (10 minutes, 15 minutes, 30 minutes, etc.). In another example, a camera may determine that the user has partially closed or fully closed his or her eyes. The system may deem such lack of movement, partial closing of the eyes, or full closing of the eyes as indications that the user is falling asleep.

At block 208, the system adjust one or more environmental controls in response to detecting that the user is falling asleep. In various implementations, the system enters a television sleep mode in response to determining that the user is falling or has fallen asleep. In various implementations, the system may enable the user 306 to set television 304 to sleep mode. In this example, the system begins adjusting one or more environmental controls before the user starts to fall asleep. When the user starts to actually fall asleep, the system continues to adjust the one or more environmental controls until they reach target values.

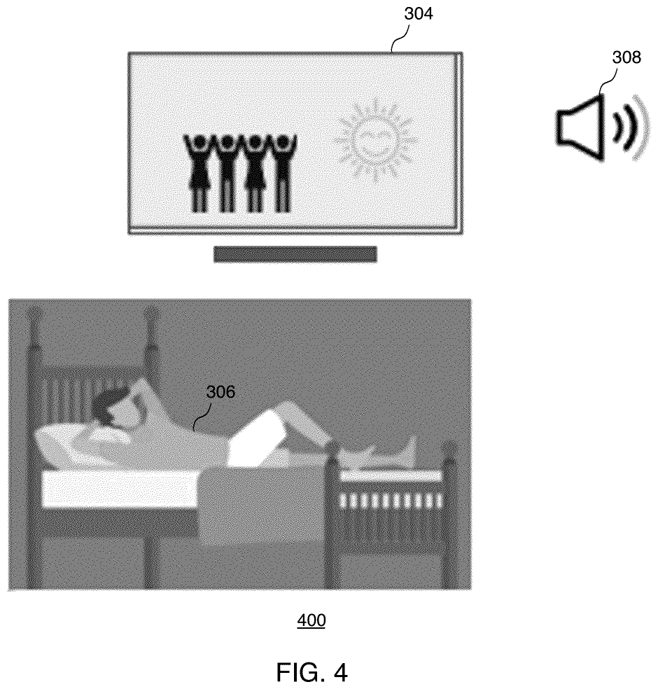

During the television sleep mode, the system adjusts the environmental controls. In various implementations, the one or more environmental controls include a brightness of the screen of the television. In various implementations, the one or more environmental controls include a volume of speakers of the television. Various example implementations directed to adjusting of brightness of the television screen, the volume, and other environmental controls are described in detail below in connection with FIGS. 4 to 6, for example.

FIG. 4 is an example block diagram showing a subsequent phase 400 of the sleep scenario, according to some implementations. Shown is television 304, user 306, and speaker 308. In this example scenario, user 306 is ready to go to sleep.

In this example scenario, where television 304 goes to sleep mode, the system starts to adjust the television settings to sleep friendly or sleep supporting values. The ultimate sleep supporting values may vary, depending on the particular implementation. For example, in this scenario, the brightness of the television screen is lowered (e.g., to 80%, 75%, 70%, etc.). Also, the sound from the speakers is lowered (e.g., to 50%, 45%, 40%, etc.). The sleep supporting values may be based on the user's preferences.

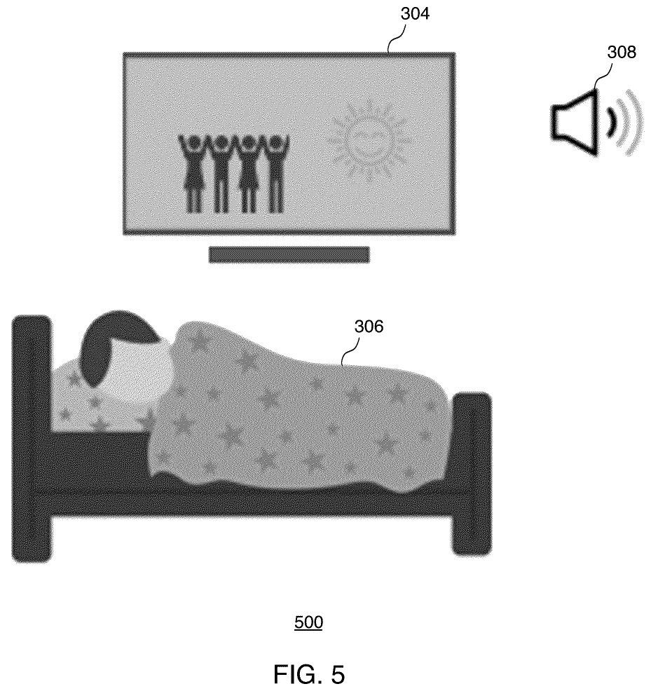

FIG. 5 is an example block diagram showing a subsequent phase 500 of the sleep scenario, according to some implementations. Shown is television 304, user 306, and speaker 308. In this example scenario, user 306 is falling asleep.

In this example scenario, the system continues to adjust the television settings to target sleep friendly or sleep supporting values. In various implementations, the system gradually and incrementally lowers dims the brightness of the television screen and lowers the sound for optimal sleeping conditions. The sleep supporting values at each phase may vary, depending on the particular implementation. For example, in this scenario, the brightness of the television screen is further lowered (e.g., to 50%, 40%, 25%, etc.). Also, the sound from the speakers is lowered (e.g., to 30%, 25%, 20%, etc.). In various embodiments, the system may utilize AI and ML techniques to determine each incremental change of each value of the one or more environmental controls. By the system making such adjustments to the environmental controls, the system enables the user to fall asleep with television on without later being awakened by television content (e.g., bright screen, loud sounds, etc.). For example, the system may muffle any loud content on a television program.

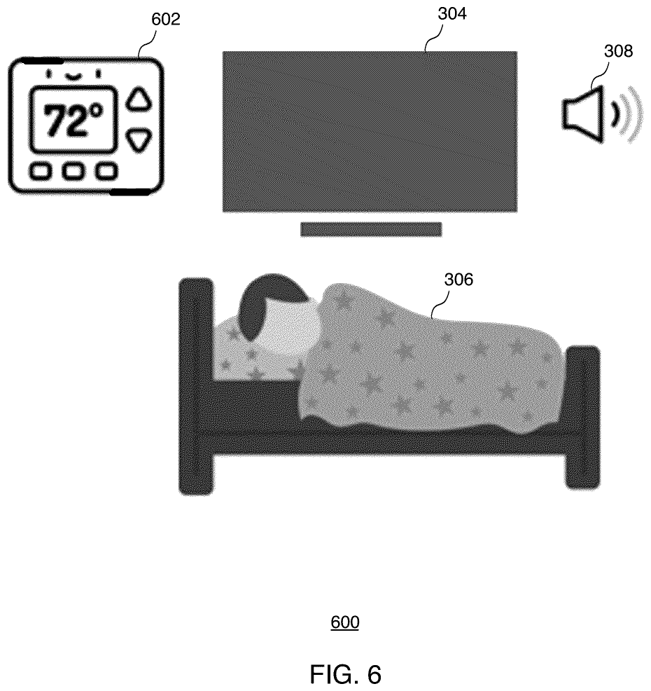

FIG. 6 is an example block diagram showing a final phase 600 of the sleep

scenario, according to some implementations. Shown is television 304, user 306, and speaker 308, and temperature controller 602. In this example scenario, user 306 has fallen asleep.

In this example scenario, the system finalizes adjusting the television settings to sleep friendly or sleep supporting values. In this scenario, the brightness of the television screen is further lowered (e.g., to 10%, 5%, 0%, etc.). Also, the sound from the speakers is lowered (e.g., to 10%, 5%, 0%, etc.).

In various implementations, if the system detects that user 306 is tossing and turning while asleep (e.g., in the middle of the night, etc.), the system may determine that user 306 is starting to wake up or is not sleeping well. The system may initiation further adjustments to the environment controls, such as adjusting the temperature. For example, in various implementations, the system adjusts the environment to keep the user sleeping by adding in some audio. The type of audio may vary, depending on the particular implementation. For example, the system may provide the audio or sound from the TV. The sound may be white noise, pink noise, brown noise, metronome, lullabies, nature sounds, etc.). In some implementations, the system may also adjust the lighting by closing the blinds, adjust the temperature, etc. In some implementations, the system may raise the bed of the user to reduce snoring of the user or of a partner.

In some implementations, the system may detect sleep problems and alert the user or if a continuous positive airway pressure (CPAP) machine associated with the user malfunctions. In some implementations, the system may utilize a microphone to detect sleep. For example, the system may detect deep sleep breathing, snoring, a baby crying, etc. A camera could detect waking movements, tossing and turning, loss of a blanket, etc. The system may also track and share with the user how the user slept, and the system may suggest ways to improve sleep. Examples of further adjustments are described in more detail below.

In various implementations, the system may check the room temperature based on temperature measurements performed by temperature controller 602. The system may adjust the temperature to support a sleep conducive environment (e.g., lower the temperature, raise the temperature, etc.). In various implementations, the system may initiate at the temperature control at any point during any of the phases described herein and/or if the system detects the user beginning to wake up in the middle of the night.

In various implementations, the system may also introduce therapeutic aroma via an aroma dispenser (not shown) to provide a relaxing scent. In various implementations, the system may cause the aroma dispenser to dispense a scene at any point during any of the phases described herein and/or if the system detects the user beginning to wake up in the middle of the night.

In various implementations, the system may adjust the temperature and introduce a relaxing scent. In various implementations, the system may also introduce subtle white noise via speak 308. In various implementations, the system may initiate white noise at any point during the phases described herein in connection with FIGS. 5 and 6 and/or if the system detects the user beginning to wake up in the middle of the night. In some implementations, the system may adjust light frequencies to be more conducive to sleep. For example, in some implementations, the system may reduce or eliminate blue light hues. In some implementations, the system may increase red light hues.

In some implementations, if the system detects that the user is waking up and the time of day is a typical wakeup time (e.g., 7:00 a.m., 8:00 a.m., etc.) or a wakeup time set by the user, the system might not introduce additional sleep-inducing elements. For example, in some implementations, the system may introduce one or more sleep-inducing elements (e.g., warmer temperature, white noise, relaxing scent, etc.) if the system detects that the user is waking up during a predetermined time range (e.g., between 12:00 a.m. and 6:00 a.m., etc.) but not after a wakeup time. In various implementations, the system may perform AI and ML techniques to optimize adjustments for a sleep supporting environment, including the wakeup time.

In various implementations, the system adjusts values of the one or more environmental controls based on artificial intelligence and machine learning. For example, a subsequent time that the television goes into sleep mode, the system may use the new values of the environmental control parameters as target values.

In various implementations, the system determines a combination of values of the one or more environmental controls that aid the user in staying asleep using artificial intelligence and machine learning. For example, the system may determine the settings of the environmental control parameters as the user starts waking up in the middle of the night. These environmental control parameters may include those described herein, such as television screen brightness, television volume, temperature, etc. As the system adjusts the various environmental control parameters, if the system determines that the user has fallen back asleep (e.g., stopped moving after a predetermined number of minutes), the system logs the values of the environmental control parameters.

In various implementations, the system obtains one or more user preferences. In some implementations, the system modifies one or more of the environmental control parameters (e.g., screen brightness, volume, aroma, white noise, etc.) based on the one or more user preferences. In some implementations, the system may provide custom settings for user to tailor sleep mode to their preferences (e.g., select sound types, content types, set timer, etc.). Sleep mode provides energy savings due to low brightness, and helps users to feel more comfortable sleeping with television on all night.

In some implementations, the system may facilitate children in taking daytime naps, as some children sleep with sound machines and night lights. Going to sleep to a program and having program slowly transition to white noise and calm imagery may support ease of napping.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

As indicated herein, in various implementations, the system may use artificial intelligence and machine learning techniques to perform operations associated with implementations described herein. In various implementations, the system may use a machine learning model to implement various artificial intelligence and machine learning techniques.

In various implementations, the system may use a set of collected data for a training set to create and train the machine learning model. The training set may include known data patterns and sequences, and known outcomes. The system repeatedly evaluates the machine learning model, which generates predictions based on collected data, and adjusts outcomes based upon the accuracy of the predictions. In some implementations, the machine learning model may learn through training by comparing predictions to known outcomes. As training progresses, the predictions of the machine learning model become increasingly accurate. In various implementations, the machine learning model may be based on various classification methods for time series analysis models such as random forest (RF), naïve model, exponential smoothing Model, autoregressive moving average (ARIMA), seasonal autoregressive moving average (SARIMA), linear regression, etc. In some implementations, the machine learning model may be based on machine learning methods such as multi-layer perceptron, recurrent neural network, and/or long short-term memory, etc. In various implementations, once training and setup are complete and evaluations become satisfactory, the machine learning model may function as a decision engine that can render determinations and decisions used by the system for carrying out implementations described herein.

Implementations described herein provide various benefits. For example, implementations improve a user's television experience by enabling the user to fall asleep in front of the television and altering the television environment to be conducive to sleep.

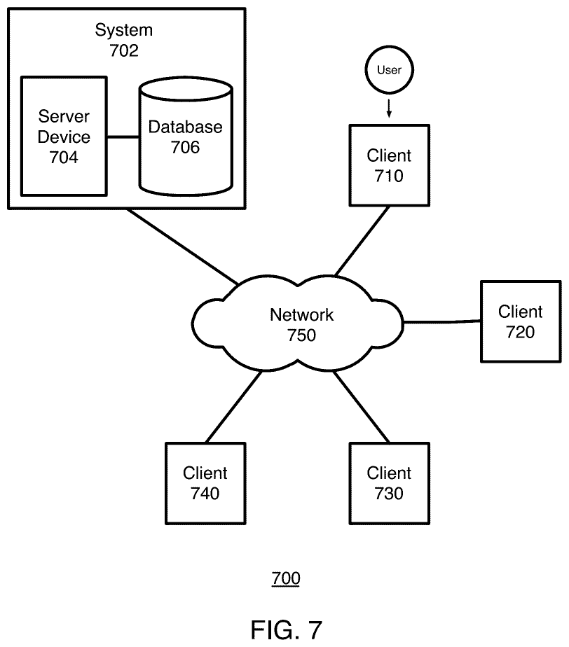

FIG. 7 is a block diagram of an example network environment 700, which may be used for some implementations described herein. In some implementations, network environment 700 includes a system 702, which includes a server device 704 and a database 706. For example, system 702 may be used to implement system 102 of FIG. 1, as well as to perform implementations described herein. Network environment 700 also includes client devices 710, 720, 730, and 740, which may communicate with system 702 and/or may communicate with each other directly or via system 702. Network environment 700 also includes a network 750 through which system 702 and client devices 710, 720, 730, and 740 communicate. Network 750 may be any suitable communication network such as a Wi-Fi network, Bluetooth network, the Internet, etc.

In various implementations, client device 710 may represent television 104 of FIG. 1. Clients 720, 730, and 740 may different televisions in a household. Database 706 may represent any database or combination of databases.

For ease of illustration, FIG. 7 shows one block for each of system 702, server device 704, and network database 706, and shows four blocks for client devices 710, 720, 730, and 740. Blocks 702, 704, and 706 may represent multiple systems, server devices, and network databases. Also, there may be any number of client devices. In other implementations, environment 700 may not have all of the components shown and/or may have other elements including other types of elements instead of, or in addition to, those shown herein.

While server device 704 of system 702 performs implementations described herein, in other implementations, any suitable component or combination of components associated with system 702 or any suitable processor or processors associated with system 702 may facilitate performing the implementations described herein.

In the various implementations described herein, a processor of system 702 and/or a processor of any client device 710, 720, 730, and 740 cause the elements described herein (e.g., information, etc.) to be displayed in a user interface on one or more display screens.

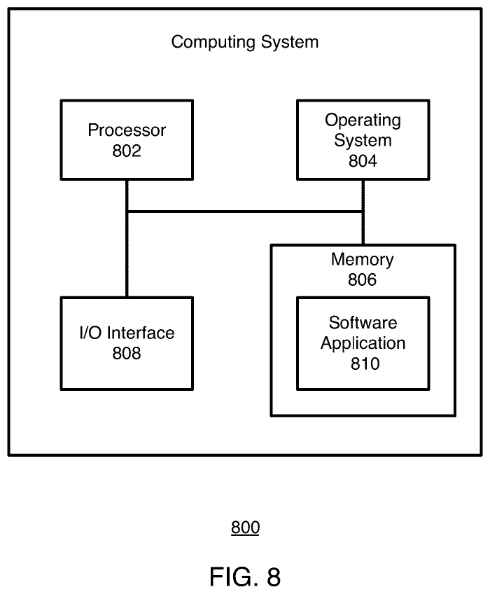

FIG. 8 is a block diagram of an example computer system 800, which may be used for some implementations described herein. For example, computer system 800 may be used to implement server device 704 of FIG. 7 and/or system 102 of FIG. 1, as well as to perform implementations described herein. In some implementations, computer system 800 may include a processor 802, an operating system 804, a memory 806, and an input/output (I/O) interface 808. In various implementations, processor 802 may be used to implement various functions and features described herein, as well as to perform the method implementations described herein. While processor 802 is described as performing implementations described herein, any suitable component or combination of components of computer system 800 or any suitable processor or processors associated with computer system 800 or any suitable system may perform the steps described. Implementations described herein may be carried out on a user device, on a server, or a combination of both.

Computer system 800 also includes a software application 810, which may be stored on memory 806 or on any other suitable storage location or computer-readable medium. Software application 810 provides instructions that enable processor 802 to perform the implementations described herein and other functions. Software application may also include an engine such as a network engine for performing various functions associated with one or more networks and network communications. The components of computer system 800 may be implemented by one or more processors or any combination of hardware devices, as well as any combination of hardware, software, firmware, etc.

For ease of illustration, FIG. 8 shows one block for each of processor 802, operating system 804, memory 806, I/O interface 808, and software application 810. These blocks 802, 804, 806, 808, and 810 may represent multiple processors, operating systems, memories, I/O interfaces, and software applications. In various implementations, computer system 800 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (Saas) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
detecting that a television is on;
detecting a user in front of the television based on one or more sensor devices;
detecting that the user is falling asleep in front of the television while the television is on based on the one or more sensor devices;
adjusting one or more environmental controls in response to detecting that the user is falling asleep, wherein the adjusting of the one or more environmental controls based on artificial intelligence and machine learning; and
computing each incremental change of the incremental changes of each of the one or more environmental controls based on the artificial intelligence and the machine learning to enable the user to fall asleep with the television on.

2. The system of claim 1, wherein the one or more sensor devices comprises a motion sensor device.

3. The system of claim 1, wherein the one or more sensor devices comprises a camera device.

4. The system of claim 1, wherein the one or more environmental controls comprise a brightness of a screen of the television.

5. The system of claim 1, wherein the one or more environmental controls comprise a volume of speakers of the television.

6. (canceled)

7. The system of claim 1, wherein the logic when executed is further operable to cause the one or more processors to perform operations comprising determining a combination of values of the one or more environmental controls that aid the user in staying asleep using artificial intelligence and machine learning.

8. A non-transitory computer-readable storage medium with program instructions stored thereon, the program instructions when executed by one or more processors are operable to cause the one or more processors to perform operations comprising:
detecting that a television is on;
detecting a user in front of the television based on one or more sensor devices;
detecting that the user is falling asleep in front of the television while the television is on based on the one or more sensor devices;
adjusting one or more environmental controls in response to detecting that the user is falling asleep, wherein the adjusting of the one or more environmental controls based on artificial intelligence and machine learning; and
computing each incremental change of the incremental changes of each of the one or more environmental controls based on the artificial intelligence and the machine learning to enable the user to fall asleep with the television on.

9. The computer-readable storage medium of claim 8, wherein the one or more sensor devices comprises a motion sensor device.

10. The computer-readable storage medium of claim 8, wherein the one or more sensor devices comprises a camera device.

11. The computer-readable storage medium of claim 8, wherein the one or more environmental controls comprise a brightness of a screen of the television.

12. The computer-readable storage medium of claim 8, wherein the one or more environmental controls comprise a volume of speakers of the television.

13. (canceled)

14. The computer-readable storage medium of claim 8, wherein the instructions when executed are further operable to cause the one or more processors to perform operations comprising determining a combination of values of the one or more environmental controls that aid the user in staying asleep using artificial intelligence and machine learning.

15. A computer-implemented method comprising:
detecting that a television is on;
detecting a user in front of the television based on one or more sensor devices;
detecting that the user is falling asleep in front of the television while the television is on based on the one or more sensor devices;
adjusting one or more environmental controls in response to detecting that the user is falling asleep, wherein the adjusting of the one or more environmental controls based on artificial intelligence and machine learning; and
computing each incremental change of the incremental changes of each of the one or more environmental controls based on the artificial intelligence and the machine learning to enable the user to fall asleep with the television on.

16. The method of claim 15, wherein the one or more sensor devices comprises a motion sensor device.

17. The method of claim 15, wherein the one or more sensor devices comprises a camera device.

18. The method of claim 15, wherein the one or more environmental controls comprise a brightness of a screen of the television.

19. The method of claim 15, wherein the one or more environmental controls comprise a volume of speakers of the television.

20. (canceled)
